(19) United States
(12) Patent Application Publication
(10) Pub. No.: US 2009/0041434 A1
(43) Pub. Date: Feb. 12, 2009

(54) Information recording/reproducing apparatus and information recording method

(75) Inventor: Hiroyuki Marumori, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/082,604

(22) Filed: Apr. 11, 2008

(30) Foreign Application Priority Data
Aug. 9, 2007 (JP) 2007-208606

(51) Int. Cl. H04N 7/26

(52) U.S. Cl. 386/124; 386/E05.001

(57) ABSTRACT

A finalizing process is executed according to a user direction without automatically performing the finalizing process. When a dubbing process is directed via an operating switch, a controlling microcomputer unit executes the dubbing process onto a hard disk drive or a disc medium unit on a condition that an apparatus is driven not by the battery, but by the AC source, i.e., uses electric power from an external power input unit. When the finalizing process is directed via the operating switch, the unit executes the finalizing process on the hard disk drive or the disc medium unit 108 on a condition that the apparatus is driven not by the battery, but by the AC source, i.e., uses electric power from the external power input unit.

### CROSS-REFERENCES TO RELATED APPLICATIONS

This application relates to and claims priority from Japanese Patent Application No. 2007-208606, filed on Aug. 9, 2007, the entire disclosure of which is incorporated herein by reference.

### BACKGROUND

1. Field of the Invention

The present invention relates to an information recording/reproducing apparatus and an information recording method that can record information on an information medium such as a BD-R and reproduce the recorded information.

2. Description of Related Art

In recent years, because of the digitalization of video and audio in the area of video and audio information and the improvement of compression techniques for video and audio data, the recording is rapidly shifting from recording on a tape including a VTR to recording on a disc such as a DVD (Digital Versatile Disc) and a hard disk drive (HDD). A representative example includes an HDD & DVD hybrid recorder which comprises both HDD and DVD drivers. Such a recorder records video or audio information from a broadcast station or an external input terminal on the HDD, for example, and then records, or (so-called) dubs, the information onto the DVD disc as a backup if a user wishes to save the information. A recorder has been proposed that stops one drive of the HDD or the DVD for power-saving when the information is dubbed by the HDD and DVD combination recorder (see Japanese Patent Laid-Open No. 2004-159225).

On the other hand, also in the home camera market, a recording medium has been shifting from a tape to a disc. As a result, various kinds of cameras have been commercialized such as a DVD camera with an 8 cm DVD disc or an HDD camera with a small HDD as a medium. For these kinds of cameras, if a blu-ray disc is used as a medium, it is convenient for a hybrid type equipped with an HDD to have a function of dubbing onto a BD-R (Blu-Ray Disc Recordable) disc similarly to the recorder. In that case, finalizing is preferably performed during the dubbing onto a BD-R disc for compatibility with a BD (Blu-Ray Disc) player.

A hybrid-type camera equipped with an HDD is used to shoot a large number of images, differently from a recorder. As such, the capacity of a dubbing target disc rarely becomes full at single-time dubbing, but the dubbing is performed after shooting a number of images. Therefore, it is not always preferable for a camera to perform automatic finalizing during the dubbing. That is, since a video camera performs the finalizing less frequently than a recorder at each time of the dubbing, automatic finalizing may annoys a user. Additionally, a camera, which is typically battery-driven, may exhaust the battery if it performs the dubbing and finalizing processes at the same time.

Therefore, it is an object of the present invention to provide an information recording/reproducing apparatus for executing a finalizing process according to a user direction without automatically performing the finalizing process.

### SUMMARY

To solve the above problem, the present invention is characterized in that a finalizing process is not automatically performed during execution of the finalizing process on a storage medium; instead, when the execution of a dubbing process or the finalizing process, for example, is directed, the dubbing process onto a first medium or a second medium is executed on a condition that the apparatus is supplied with electric power from a first power supply (external AC source), and the finalizing process on the first medium or the second medium is executed on a condition that the apparatus is supplied with electric power from the first power supply.

The present invention is also characterized in that selection information to select either of the execution of the dubbing process or the execution of the dubbing process and the finalizing process is displayed on a display unit on a condition that the apparatus is supplied with electric power from the first power supply or remaining charge in the second power supply (battery) exceeds a predetermined amount.

According to the present invention, the finalizing process can be executed according to a direction without automatically performing the finalizing process.

### BRIEF DESCRIPTION OF THE DRAWINGS

FIG. 1 is a block diagram of an information recording/reproducing apparatus showing one embodiment of the present invention;

FIG. 2 is a flow chart illustrating a dubbing process according to the first embodiment;

FIG. 3 is a flow chart illustrating a finalizing process according to the first embodiment; and

FIG. 4 is a flow chart illustrating a dubbing process according to a second embodiment.

### DETAILED DESCRIPTION OF PREFERRED EMBODIMENTS

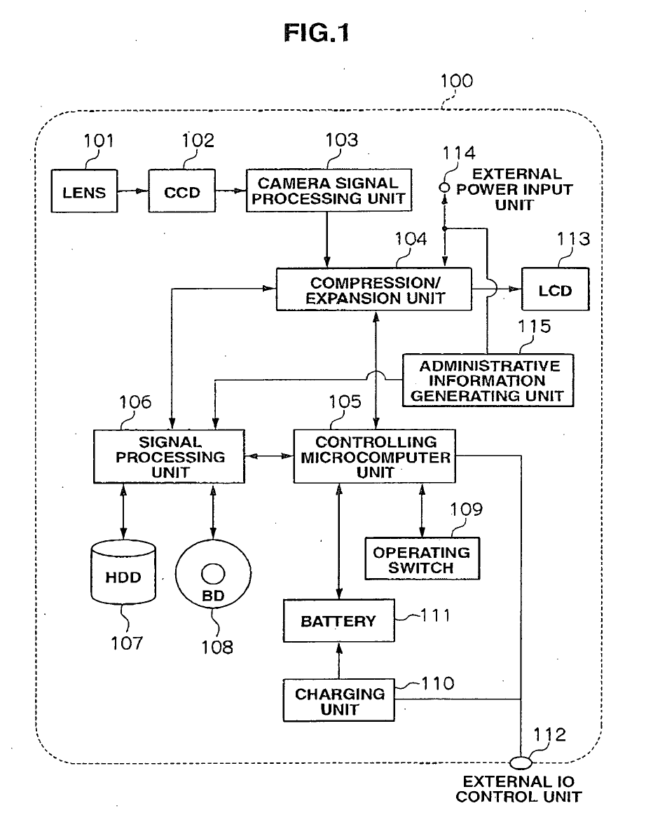

The following will describe embodiments of the present invention with reference to the drawings. FIG. 1 is a block diagram of an information recording/reproducing apparatus showing one embodiment of the present invention.

In FIG. 1, an information recording/reproducing apparatus 100, which is a BD hybrid camera, comprises a lens 101, an imaging sensor (CCD) 102, a camera signal processing unit 103, a compressing/expanding unit 104, a controlling microcomputer unit 105, a signal processing unit 106, a hard disk drive (HDD) 107, a disc medium (for example, a BD or DVD) unit 108, an operating switch 109, a charging unit 110, a battery 111, an external power input unit 112, an LCD display (LCD) 113, an external output interface (I/F) 114 and an administrative information generating unit 115.

The lens 101, the imaging sensor (CCD) 102 and the camera signal processing unit 103 constitute a camera unit for imaging a subject and generating a video signal as video information. The signal processing unit 106 records the video signal from the camera signal processing unit 103 or video information from the outside on the hard disk drive (HDD) 107 as a first medium and the disc medium (for example, a BD or DVD) unit 108 as a second medium, or reproduces the video information from said first and second media. The LCD display (LCD) 113 is a display unit for displaying the video information processed by the signal processing unit 106 as an image.

Particularly, the information recording/reproducing apparatus 100 captures an image of a subject by the CCD 102 via the lens 101. The image captured by the CCD 102 is converted to an electric signal and then converted to a video signal by the camera signal processing unit 103.

Subsequently, the video signal outputted from the camera signal processing unit 103 is converted to a digital video signal by the signal compressing/expanding unit 104 controlled by the controlling microcomputer unit 105. A video signal inputted from the outside can also be converted to a digital video signal by switching the input to the external input/output terminal 114.

The signal converted to the digital video signal is recorded on an external storage such as a BD, DVD or HDD by the signal processing unit 106. In this way, data is recorded on a medium such as a BD-R (Blu-ray Disc Recordable) disc formatted in the UDF 2.6, for example. If administrative information such as MD information and MDM information needs to be updated depending on addition of user data, for example, then the administrative information generating unit 115 generates the administrative information, and the generated administrative information is recorded on a medium.

It is possible to control the controlling microcomputer unit 105 by manipulating the operating switch 109, read out a video signal recorded on a BD or DVD by the signal processing unit 106, and process dubbing between the media by recording the signal on an HDD. Similarly, it is also possible to read out the video signal recorded on the HDD and record the signal on the BD or DVD.

The signal recorded on the storage can be expanded into a video signal by the video compressing/expanding unit 104, outputted to the input/output terminal 114 and displayed on the LCD display 113. A display is not limited to the LCD display 113, but an organic EL display can also be used, for example.

The external power input unit 112, which is a power supply unit, converts alternating-current power from the AC source into direct-current power when AC power is supplied from the outside, and can supply the converted direct-current power to the charging unit 110 and the controlling microcomputer unit 105. The external power input unit 112 supplies power so that the charging unit 110 can charge the battery 111.

With the above configuration, external power supply can also cause the equipment to operate while the external power input unit 112 supplies power, and power supply from the battery 111 can cause the equipment to operate while the external power is not supplied. The apparatus does not need to have all functions necessary for the charging, but it can have part or all of the functions necessary for the charging other than the external power input unit.

On a condition that the apparatus is supplied with electric power from the external power input unit 112, the controlling microcomputer unit 105 functions as a controller for directing the signal processing unit 106 to perform a dubbing process onto the hard disk drive (HDD) 107 as a first medium and the disc medium unit 108 as a second medium, and commanding the signal processing unit 106 to perform the dubbing process onto the hard disk drive (HDD) 107 and the disc medium unit 108.

The controlling microcomputer unit 105 further functions as a controller for displaying selection information to select either of execution of the dubbing process or execution of the dubbing process or a finalizing process on the LCD display (LCD) 113 on a condition that the apparatus is supplied with electric power from the external power input unit 112 or remaining charge in the battery (second power supply) 111 exceeds a pre-determined amount.

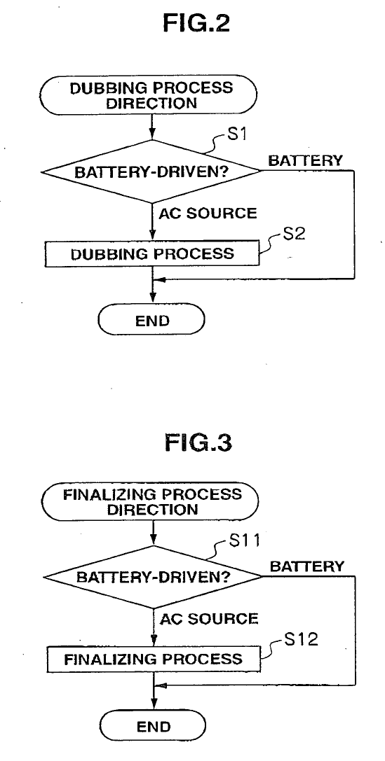

Particularly, when a dubbing process is directed via the operating switch 109, the controlling microcomputer unit 105 determines whether or not the apparatus is driven by the battery 111 (S1) as shown in FIG. 2. If the apparatus is not driven by the battery 111, but driven by the AC source using electric power from the external power input unit 112, the unit 105 executes the dubbing process onto the hard disk drive (HDD) 107 or the disc medium unit 108 (S2), and then finishes the processing in this routine. If the apparatus is driven by the battery 111, it immediately finishes the processing in this routine.

Next, when a finalizing process is directed via the operating switch 109, the controlling microcomputer unit 105 determines whether or not the apparatus is driven by the battery 111 (S11) as shown in FIG. 3. If the apparatus is not driven by the battery 111, but driven by the AC source using electric power from the external power input unit 112, the unit 105 executes the finalizing process on the hard disk drive (HDD) 107 or the disc medium unit 108 (S12), and then finishes the processing in this routine. If the apparatus is driven by the battery 111, it immediately finishes the processing in this routine.

According to this embodiment, on a condition that the apparatus is supplied with electric power from the external power input unit 112 during the dubbing, the finalizing process can be executed according to a direction without automatically executing the finalizing process.

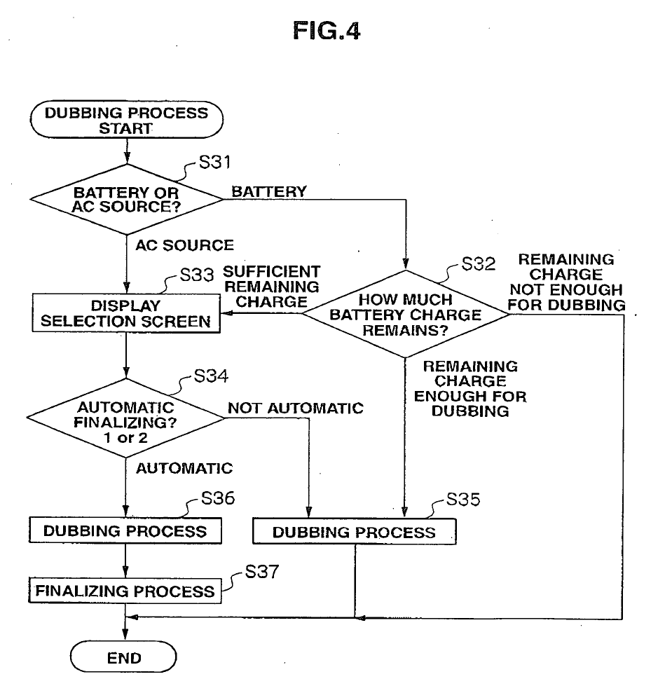

Next, the operation of a second embodiment will be described with reference to the flow chart in FIG. 4. First, when a dubbing process is directed via the operating switch 109, the controlling microcomputer unit 105 determines whether the apparatus is driven by the battery 111 or driven by the AC source (S31). If the apparatus is driven by the battery 111, it determines remaining charge in the battery 111 (S32). If the remaining charge in the battery 111 exceeds a pre-determined amount, i.e., the remaining charge is sufficient, it displays a selection screen on the LCD display (LCD) 113 (S33). If the remaining charge in the battery 111 is less than the pre-determined amount but is enough for a dubbing process, it orders the signal processing unit 106 to perform the dubbing process (S35). If the remaining charge in the battery 111 is less than the pre-determined amount and not enough for the dubbing process, it finishes the processing in this routine.

Otherwise, if the controlling microcomputer unit 105 determines at step S31 that the apparatus is not driven by the battery 111 but driven by the AC source, i.e., uses electric power from the external power input unit 112, it displays a selection screen on the LCD display 113 (S33). For example, it displays selection information to prompt to select either of (1) execution of only the dubbing process (no automatic finalizing) or (2) execution of the dubbing process and the finalizing process (automatic finalizing) on the screen on the LCD display 113.

In the above, if a user selects (1) execution of only the dubbing process (no automatic finalizing) by manipulating the operating switch 109, the controlling microcomputer unit 105 orders the signal processing unit 106 to perform the dubbing process (S35), and then finishes the processing in this routine. At this time, the signal processing unit 106 executes the dubbing process onto the hard disk drive (HDD) 107 or the disc medium unit 108.

Otherwise, if the user selects (2) execution of the dubbing process and the finalizing process (automatic finalizing) by manipulating the operating switch 109, the controlling microcomputer unit 105 orders the signal processing unit 106 to perform the dubbing process (S36), subsequently orders the signal processing unit 106 to perform the finalizing process (S37), and then finishes the processing in this routine. At this time, the signal processing unit 106 executes the dubbing process onto the hard disk drive (HDD) 107 or the disc medium unit 108, and then executes the finalizing process on the hard disk drive (HDD) 107 or the disc medium unit 108.

According to this embodiment, on a condition that the apparatus is supplied with electric power from the external power input unit 112 or remaining charge in the battery 111 exceeds a predetermined amount during the dubbing, either of execution of only the dubbing process or execution of the dubbing process and the finalizing process can be selected according to user operation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An information recording/reproducing apparatus including a camera unit for imaging a subject and generating video information, a signal processing unit for recording the video information from said camera unit or the outside on a first medium and a second medium or reproducing said video information from said first medium and the second medium, first power supply, second power supply, a display unit for displaying said video information as an image, and a controller for controlling all the units, wherein said controller:
directs said signal processing unit to perform a dubbing process onto said first medium or second medium on a condition that the apparatus is supplied with electric power from said first power supply; and
commands said signal processing unit to perform a finalizing process on said first medium or second medium on a condition that the apparatus is supplied with electric power from said first power supply.

2. The information recording/reproducing apparatus according to claim 1, wherein said controller displays selection information of the dubbing process and the finalizing process on said display unit on a condition that the apparatus is supplied with electric power from said first power supply or remaining charge in said second power supply exceeds a pre-determined amount.

3. The information recording/reproducing apparatus according to claim 1, wherein said controller displays selection information to select either of execution of the dubbing process or execution of the dubbing process and the finalizing process on said display unit on a condition that the apparatus is supplied with electric power from said first power supply or remaining charge in said second power supply exceeds a pre-determined amount.

4. The information recording/reproducing apparatus according to claim 1, wherein said first medium is a hard disk drive (HDD) and said second medium is an optical disc.

5. The information recording/reproducing apparatus according to claim 1, wherein said first power supply is external power supply and said second power supply is a battery.

6. An information recording/reproducing method for an information recording/reproducing apparatus including a camera unit for imaging a subject and generating video information, a signal processing unit for recording the video information from said camera unit or the outside on a first medium and a second medium or reproducing said video information from said first medium and the second medium, first power supply, second power supply, a display unit for displaying said video information as an image, and a controller for controlling all the units, the method of recording video or audio in either of said media or reproducing video or audio from either of said media by a process by said controller including:
a first step of executing a dubbing process onto said first medium or second medium on a condition that the apparatus is supplied with electric power from said first power supply; and
a second step of executing a finalizing process on said first medium or second medium on a condition that the apparatus is supplied with electric power from said first power supply.

7. The information recording/reproducing method according to claim 6 including a third step of displaying selection information of the dubbing process and the finalizing process on said display unit on a condition that the apparatus is supplied with electric power from said first power supply or remaining charge in said second power supply exceeds a pre-determined amount.

8. The information recording/reproducing method according to claim 6 including a third step of displaying selection information to select either of execution of the dubbing process or execution of the dubbing process and the finalizing process on said display unit on a condition that the apparatus is supplied with electric power from said first power supply or remaining charge in said second power supply exceeds a predetermined amount.
